(19) United States
(12) Patent Application Publication
(10) Pub. No.: US 2023/0107143 A1
(43) Pub. Date: Apr. 6, 2023

(54) EVENT-BASED USER MATCHING

(71) Applicant: Dual Brothers Capital, LLC, Royce City, TX (US)

(72) Inventors: John Guard, Plano, TX (US); Scott Park, Royce City, TX (US)

(21) Appl. No.: 17/960,423

(22) Filed: Oct. 5, 2022

Related U.S. Application Data
(60) Provisional application No. 63/277,851, filed on Nov. 10, 2021.
(60) Provisional application No. 63/252,517, filed on Oct. 5, 2021.

(51) Int. Cl. G06F 16/9535; G06Q 50/00

(52) U.S. Cl. CPC G06F 16/9535; G06Q 50/01

(57) ABSTRACT

A system, apparatus, and method for event-based user matching. The apparatus includes a memory storing instructions a processor coupled with the memory. The processor is configured to execute the instructions to cause the apparatus to identify a set of events for a user, determine a list of prospective matches for the user attending one or more of the set of events for the user, and transmit the list of prospective matches for the user.

### CROSS-REFERENCE TO RELATED APPLICATIONS

This application claims priority to U.S. Provisional Application No. 63/277,851, filed on Nov. 10, 2021, entitled “EVENT-BASED USER MATCHING.” This Application also claims priority to U.S. Provisional Application No. 63/252,517, filed on Oct. 5, 2021, entitled “EVENT-BASED USER MATCHING,” and each patent application listed in this paragraph is hereby incorporated herein by reference in its entirety as an example.

### BACKGROUND

### Technical Field

Novel aspects of the present disclosure relate to the field of computer-based user matching and more particularly to an improved system and method for matching users based on a commonality of events.

### Background

Conventional online dating platforms allow users to seek out potential matches based primarily on geographic location and a similarity of certain criteria determined by a questionnaires that a user completes during a registration process. The number of matches that a user can be provided can be extensive. From the list of matches, a user can then express interest in a match, and if the other user wants to engage, then dialogue can be started between the two users. Oftentimes, the sheer number of matches that are provided to users decreases a quality of interaction between the two and often causes users to overlook an otherwise viable match simply because of the volume of matches that are being provided. Other times, the anonymity of the interaction between two matched users also emboldens the users to be less cordial and less respectful than they would be if the initial meeting had been made in person. On some occasions, a user may be matched with fake profiles and the resulting communication may take place with computer bots or by people who have no intention of pursuing authentic relationships. In any event, these interactions waste time and erodes a user’s trust in the online dating platform.

### SUMMARY OF THE INVENTION

Novel aspects of the present disclosure are directed to apparatus and methods for event-based user matching. A first embodiment is directed to an apparatus for event-based user matching which includes a memory storing instructions and a processor coupled with the memory. The processor is configured to execute the instructions to cause the apparatus to identify a set of events for a user, determine a list of prospective matches for the user attending one or more of the set of events for the user, and transmit the list of prospective matches for the user.

A second embodiment is directed to another apparatus for event-based user matching which includes a memory storing instructions and a processor coupled with the memory. The processor is configured to execute the instructions to cause the apparatus to receive a set of events for a user, transmit the set of events to a matching server, receive a list of prospective matches for the user attending one or more of the set of events for the user, and display the list of prospective matches for the user.

A third embodiment of this disclosure is directed to a method for event-based user matching. The method includes steps of identifying a set of events for a user, determining a list of prospective matches for the user attending one or more of the set of events for the user, and transmitting the list of prospective matches for the user.

A fourth embodiment of this disclosure is directed to another method for event-based user matching. The method includes steps of receiving a set of events for a user, transmitting the set of events to a matching server, receiving a list of prospective matches for the user attending one or more of the set of events for the user, and displaying the list of prospective matches for the user.

Other aspects, embodiments and features of the invention will become apparent from the following detailed description of the invention when considered in conjunction with the accompanying figures. In the figures, each identical, or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE FIGURES

The novel features believed characteristic of the invention are set forth in the appended claims. The invention itself, however, as well as a preferred mode of use, further objectives, and advantages thereof, will be best understood by reference to the following detailed description of illustrative embodiments when read in conjunction with the accompanying figures, wherein:

FIG. 1 is a block diagram of a system for event-based matching in accordance with an illustrative embodiment;

FIG. 2 is a block diagram of a user device for event-based matching in accordance with an illustrative embodiment;

FIG. 3 is a block diagram of a server for event-based matching in accordance with an illustrative embodiment;

FIG. 4 is a Venn Diagram illustrating the set of prospective matches presented to a user in accordance with an illustrative embodiment;

FIG. 5 is a Venn Diagram illustrating the subset of prospective matches presented to a user in accordance with another illustrative embodiment;

FIG. 6 is a schematic diagram of a user’s zone of interaction depicted on a digital map in accordance with an illustrative embodiment;

FIG. 7 is a schematic diagram of a user’s zone of interaction depicted on a digital map in accordance with another illustrative embodiment;

FIG. 8 is a schematic diagram showing translation of a user’s zone of interaction depicted on a digital map in accordance with an illustrative embodiment;

FIG. 9 illustrates a modification of a user’s zone of interaction in accordance with an illustrative embodiment; and

FIG. 10 is a flowchart of a process for event-based user matching according to an illustrative embodiment.

### DETAILED DESCRIPTION

Novel aspects of this disclosure recognize the need to provide users with another filter by which to provide a user with prospective matches, namely an event-based matching or location-based matching of the user with prospective matches. Other aspects of this disclosure recognize the need to provide another way to match with users based on an open-ended invitation to users of the dating platform.

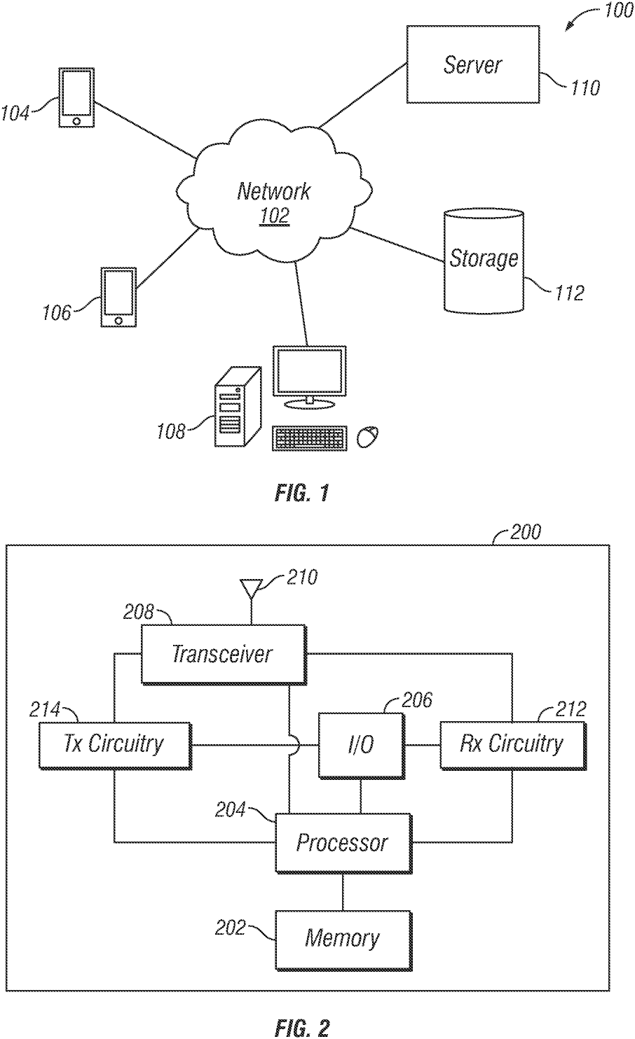

FIG. 1 is a block diagram of a system for event-based user matching in accordance with an illustrative embodiment. The system 100 includes a plurality of electronic devices communicating via a network 102 to permit users to participate in event-based user matching. Examples of user devices 104, 106, and 108 can include cell phones, tablets, desktop computers, or any other form of computing device. While user devices 104, 106, and 108 are depicted as communicating through communications link via network 102, in other embodiments, the user devices 104, 106, and 108 can communicate via device-to-device communications protocols.

In a non-limiting embodiment, users desiring to participate in an online data platform using event-based user matching first complete a registration process managed by matching server 110. Users registering via a mobile device, such as a smartphone, can download an app that prompts a user to provide answers to questions that can be used to generate the users’ profile. Users registering via a laptop or desktop computer can navigate to a dedicated website that includes the same prompts. In either scenario, matching server 110 prompts the registering user to provide a unique user ID and answers regarding the user’s attributes and characteristics, e.g., age, gender, height, weight, ethnicity, level of education, goals, etc. Users may also be asked to identify certain attributes and qualities that the user seeks in a prospective match.

The matching server 110 repeats the registration process for each user in a plurality of users to create a pool of users that can be matched to one another based, at least in part, on their own attributes and characteristics that they provided during registration, as well as the desired attributes and characteristics sought in a match. The matching server 110 can generate a user profile for each of the registered users. The plurality of user profiles can be stored locally with the matching server 110, or stored remote from the matching server, such as in network storage device 112.

In a first embodiment, users are provided with matches based on a commonality of an event. An event can be a scheduled event, such as a concert or movie. The event can also be an unscheduled event, such as a trip to the gym or to a bar for happy hour. The event can be an event that takes place at some time in the future, or the event can be an event that the user is presently attending. In this embodiment, a user attending an event and/or intending to attend a set of events at some time in the future can inform the matching server 110 of the event and/or the set of events. As used herein, the term “set” means one or more. Thus, “a set of events” can be a single event in the future or two or more events in the future.

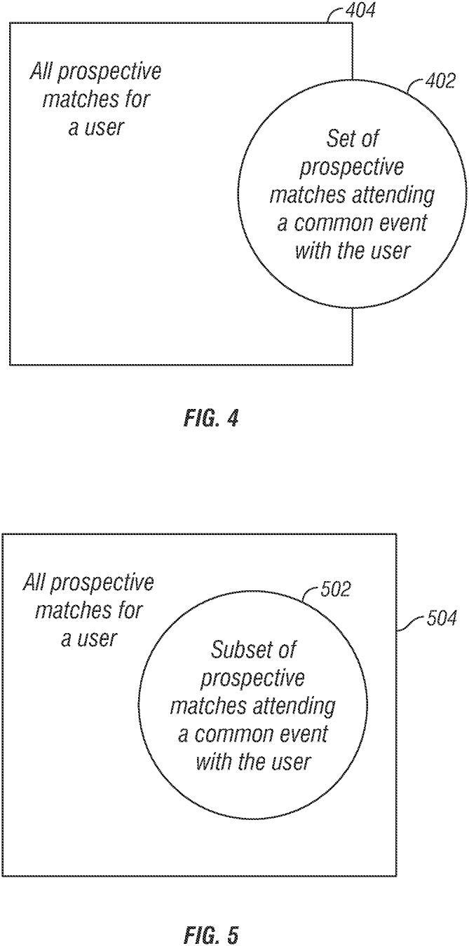

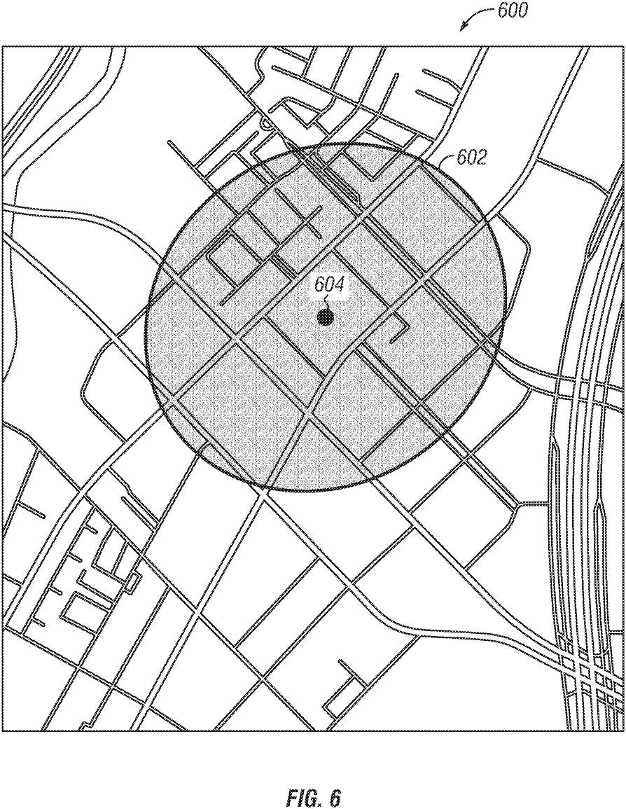

Once the matching server 110 has been notified of the event and/or the events in the set of events that the user intends to attend, the matching server will match the user with prospective matches based on a commonality of events. In one version of this embodiment, the matching server 110 provides the user with any prospective matches based solely on a commonality of the event that they are attending and/or intend to attend without regard to mutual satisfaction of specified attributes or characteristics. Attendance of the common event is the basis for providing the user with one or more prospective matches. Accordingly, prospective matches can be provided that may not satisfy the listed attributes/characteristics listed by the user during registration. For example, a user can be matched with a prospective match because both intend to attend the same concert. The match may be beneficial to allow the users to share costs, such as the cost of gas or parking fees. Likewise, two users matched for a shared trip to the gym can serve as spotters for one another. A visual depiction of this embodiment can be seen in FIG. 4 that follows. In another version of this embodiment, the attendance of a common event is just one criteria for providing a user with prospective matches. For example, the user can be provided with prospective matches from attendees of the common event, as described in more detail in FIG. 5 that follows.

Once a user has been provided with a list of prospective matches, the user can select one or more of the prospective matches from the list of prospective matches returned by the matching server 110. Selection of the one or more prospective matches can occur by conventional means. The matching server 110 can then facilitate communication between the user and the one or more prospective matches selected by the user. In one example, the user’s selection of one or more prospective matches triggers the matching server 110 to send a prompt to the one or more selected prospective matches to initiate a communication session. In another example, the user’s selection of the one or more prospective matches triggers the matching server 110 to facilitate communication between the user and the one or more selected prospective matches if the one or more selected prospective matches also identifies the user as a prospective match as well.

In another embodiment, the matching server will match users based on an open-ended invitation to users of the dating platform. For example, a requesting user notifies matching server 110 of an event that the requesting user would like to attend. The event can be a dinner at a particular restaurant, a movie at a particular theater, a concert at a particular venue, happy hour at a particular bar, or any number of different events. The requesting user can provide a preferred day and time for the event, or a plurality of days and times for the event. Once the requesting user has provided the matching server 110 the requisite event details, the matching server 110 can generate an open-ended invitation to other users of the dating platform. The open-ended invitation can be provided to every member of the dating platform or to selected members of the dating platform. The selected members of the dating platform can be based on selection and matching criteria that each user provided to the matching server 110 at registration. In the alternative, the selected members of the dating platform can be different than those users who satisfy the selection and matching criteria. The requesting user can determine the modified criteria by which the matching server 110 selects the selected members. In one example, the modified criteria can be based solely on geographic location.

One or more accepting users can accept the open-ended invitation. The requesting user can then receive a list of one or more accepting users and select one of the accepting users to accompany the requesting user to the event. Thus, the requesting user can submit an open-ended invitation requesting to be taken to an event. Alternatively, the requesting user can submit an open-ended invitation requesting the company of an accepting user to attend an event.

Once the requesting user has selected one of the accepting users, or once a particular accepting user has accepted the request from the requesting user, the matching server 110 can transmit a list of the accepting users to the requesting user to facilitate communication between the requesting user and the accepting user to coordinate attendance to the event. In the event that the accepting user is the only user that received the requesting user’s invitation, and the accepting user accepted the request from the requesting user, then the list of accepting users can include confirmation of the acceptance of the request.

FIG. 2 is block diagram of a user device for event-based matching in accordance with an illustrative embodiment. User device 200 is an exemplary mobile computing device operable by a user for participating in event-based user matching. The user device 200 can be a user device, such as user device 104 and user device 106 in FIG. 1. The user device 200 is provided for illustration only and the user devices 104 and 106 in FIG. 1 can have the same or similar configuration as the user device 200 in FIG. 2.

User device 200 includes memory 202 storing instructions that can be executed by processor 204 for controlling the operation of the user device 200. For example, the memory can store an operating system and one or more applications that can be executed by the processor 204. The memory 202 can include random access memory (RAM), Flash memory, and/or read-only memory (ROM).

I/O 206 is one or more input/output (I/O) devices of the user device 200. Examples of I/O devices include, but are not limited to, a microphone, a speaker, a camera, a touch screen, a keypad. I/O 206 enables a user to interact with the user device 200 to generate data describing an event that the user is attending or intends to attend. In some embodiments, I/O 206 also includes I/O interfaces that provide the user device 200 with communication paths with other devices, such as other user devices and peripherals.

The transceiver 208 provides a wireless communications capability with a network, such as network 100 in FIG. 1. Incoming signals are received by the transceiver 208 from the antenna 210 and processed by the receive (RX) circuity 212, which processes the signal and transmits the processed signal to an I/O device, such as a speaker, if the processed signal is for voice data. The processed signal can also be transmitted to the processor 204 for further processing before presentation to a user on another I/O device, such as a screen, if the processed signal is for other forms of data, such as web browsing data. Outgoing signals transmitted by the transceiver 208 from the antenna 210 are received from transmit (TX) circuitry 214. The TX circuitry 214 can receive voice data from a microphone, or other forms of outgoing data, such as web data, e-mail, or application data, from the processor 204.

The user device 200 in FIG. 2 is depicted as a mobile phone, the user device 200 can be any other conventional client computing devices such as tablets, laptop computers, and desktop computers, such as user device 108 in FIG. 1. Thus, the transceiver 208 and the associated processing circuitry depicted in the user device 200 can be replaced by a network communications interface that can support wired or wireless communication over a user’s home network.

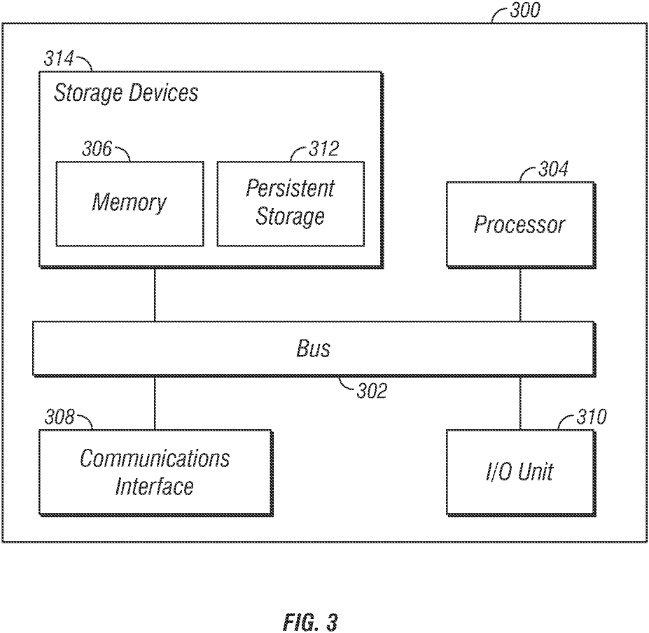

FIG. 3 is a block diagram of a server for event-based user matching according to an illustrative embodiment. For example, the server 300 can be a user-matching server 110 in FIG. 1. Server 300 includes a bus system 302 that supports communication between at least one processor 304, at least one storage device 306, at least one communications interface 308, and at least one input/output (I/O) unit 310.

The memory 306 and a persistent storage 312 are examples of storage devices 314, which represent any structure(s) capable of storing and facilitating retrieval of information (such as data, program code, and/or other suitable information on a temporary or permanent basis). The memory 306 may represent a random access memory or any other suitable volatile or non-volatile storage device(s). The persistent storage 312 may contain one or more components or devices supporting longer-term storage of data, such as a read only memory, hard drive, Flash memory, or optical disc.

The processor 304 may execute instructions that may be loaded into the memory 306. The processor 304 may include any suitable number(s) and type(s) of processors or other devices in any suitable arrangement. Example types of processors 304 include microprocessors, microcontrollers, digital signal processors, field programmable gate arrays, application specific integrated circuits, and discreet circuitry.

The communications interface 308 may support communications with other systems or devices. For example, the communications interface 308 could include a network interface card or a wireless transceiver facilitating communications over the network 102. The communications interface 308 may support communications through any suitable physical or wireless communication link(s).

The I/O unit 310 may allow for input and output of data. For example, the I/O unit 310 may provide a connection for user input through a keyboard, mouse, keypad, touchscreen, or other suitable input device. The I/O unit 310 may also send output to a display, printer, or other suitable output device.

As previously described, the server 300 can be implemented as a user-matching server in a networked computing system and can coordinate event-based matching of users.

FIG. 4 illustrates a Venn Diagram of the set of prospective matches presented to a user in accordance with an illustrative embodiment. As can be seen, the set of prospective matches attending a common event with the user, represented by circle 402, only partially overlaps the totality of prospective matches for the user based on the attributes/characteristics identified by the user during registration, which is represented by square 404. Thus, the set of prospective matches sent to a user may include individuals that do not satisfy the matching criteria.

In another embodiment, the matching server 110 considers the shared event as another metric by which to filter out prospective matches to a user. Thus, the prospective matches returned to the user will necessarily include only those prospective matches who satisfy the attributes/characteristics identified by the user during registration. FIG. 5 illustrates a Venn Diagram of the subset of prospective matches presented to a user in accordance with this illustrative embodiment. As can be seen, the subset of prospective matches attending a common event with the user, represented by circle 502, is wholly overlapped by the totality of the prospective matches for the user which satisfy the attributes/characteristics identified by the user during registration, which is represented by square 504. Thus, every prospective match provided to the user is someone that mutually satisfies matching criteria, i.e., specified attributes/characteristics, and is either presently attending the same event, i.e., in the same location at the present time, or will be attending the same event at a future time, i.e., at the same location at some future time.

In either of the immediately preceding embodiments, once a prospective match has left an event, the prospective match will be removed from the list of prospective matches provided to the user. Prospective matches who have indicated an intent to attend an event, but who have not yet arrived at the event might be displayed to a user differently than prospective matches who have already arrived at the event.

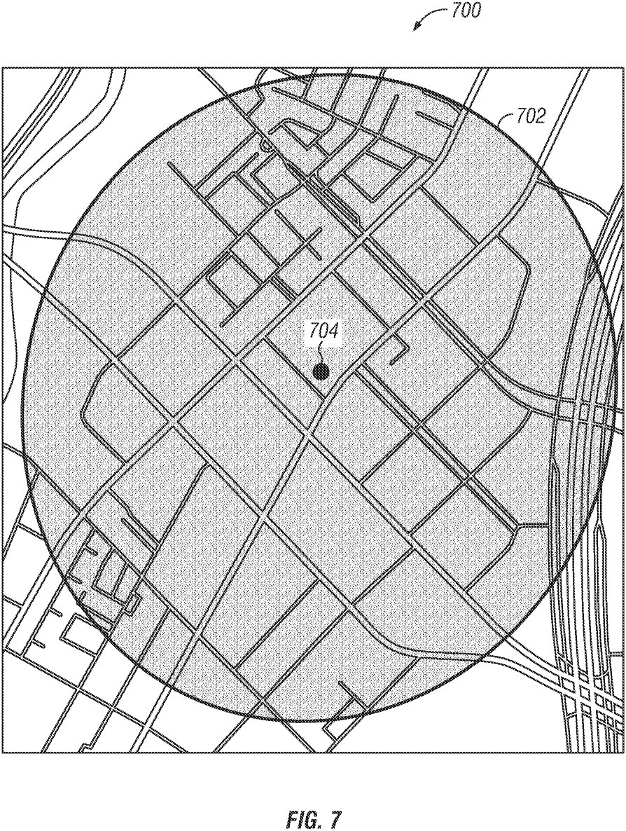

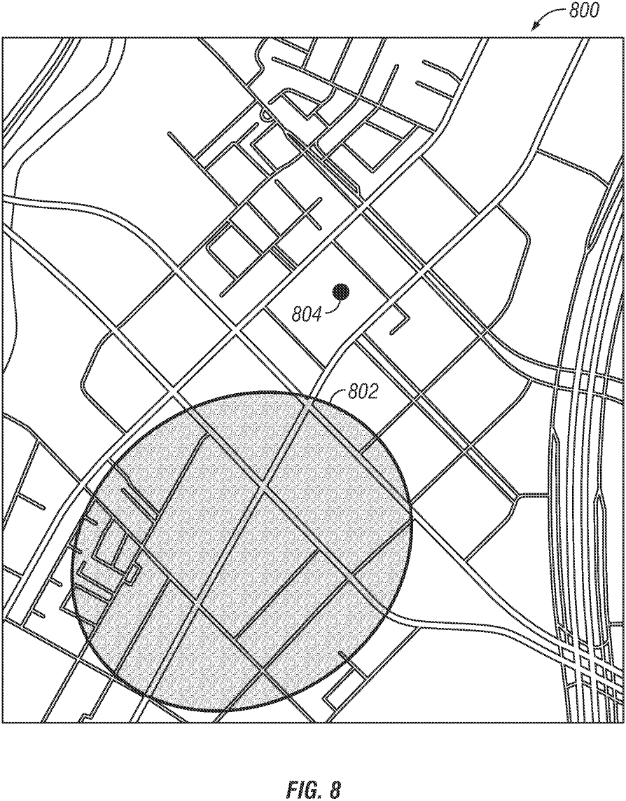

In addition to the aforementioned embodiments, or in one or more entirely different embodiments altogether, a user’s attendance at an event can be depicted visually on a digital/graphical map with the user at the center of a zone that can take the shape of a circle, or any other predetermined geometric shape. As used herein, the zone will be referred to in the alternative as the user’s “zone of interaction.” FIG. 6 is a schematic diagram of a user’s zone of interaction 602 depicted on a digital map 600 in accordance with an illustrative embodiment. The user is located at the center 604 of the zone of interaction 602. The size of the zone can be set by the user interacting with a user-interface (UI) element (not shown), such as a slider bar or with a set of radio buttons corresponding with different predetermined radii, i.e., half-mile radius, one-mile radius, two-mile radius. FIG. 7 is a schematic diagram of a user’s zone of interaction 702 depicted on a digital map 700 in accordance with another illustrative embodiment, enlarged from a radius of 0.5 miles to 2 miles. As before, the user’s location is at the center 704 of the zone of interaction 702.

The matching server 110 can provide the user with a list of prospective matches within the user’s zone of interaction. As the user moves from one location to another, the user’s zone of interaction can change, and the list of prospective matches can change accordingly so that the user is provided with a constantly updated list of prospective matches based on the size and location of the user’s zone of interaction.

In some embodiments, the user can move the zone of interaction around on the digital map, causing the matching server 110 to provide the user with continuously updated lists of prospective matches based on the location of the zone of interaction. This feature can help the user determine which current event(s) to attend based on the number of prospective matches present at the current event(s). FIG. 8 is a schematic diagram showing translation of a user’s zone of interaction 802 depicted on a digital map 800 in accordance with an illustrative embodiment. The user’s location is indicated by a marker 804.

In another embodiment, matching server 110 can identify the one or more businesses that a user visits and provide that user with a list of one or more prospective matches who also visited the same business. In one version of this embodiment, the list of prospective matches includes people who were at the same business at the same day and time as the user. In some embodiments, the matching server 110 provides matches to users to help resolve “missed connections” which can occur when two users have crossed paths at an event but were unable to conduct a meaningful interaction that could have resulted in an exchange of contact information. For example, two users may have been at the same event venue and desired to make contact with one another, but were unable to do so due to the presence of too many people or obstacles. The matching server 110 can create a list of users for display to each user based on other users who were at the same event venue. The fact that the two users met at the same event venue is at least an initial indication that the two users share some common interest. In one or more embodiments, the matching server 110 can receive descriptors from one of the users that can be used to narrow down the list of users provided. For example, race, hair color, or body type could be provided as a means to narrow the list of users provided.

In another version of this embodiment, the list of prospective matches includes people who were at the same business within a predetermined window of time as the user, e.g., within the same day, week, or month as the user. In either of the two scenarios, the user can be provided the list of prospective matches only after the user has left the business. Furthermore, the list includes only those prospective matches who have also left the business. In a variation of this embodiment, the user on the premises of a business can be provided with a list of prospective matches who have visited the same business in the past. Although this embodiment was described relative to a business, other embodiments can substitute an event for the business.

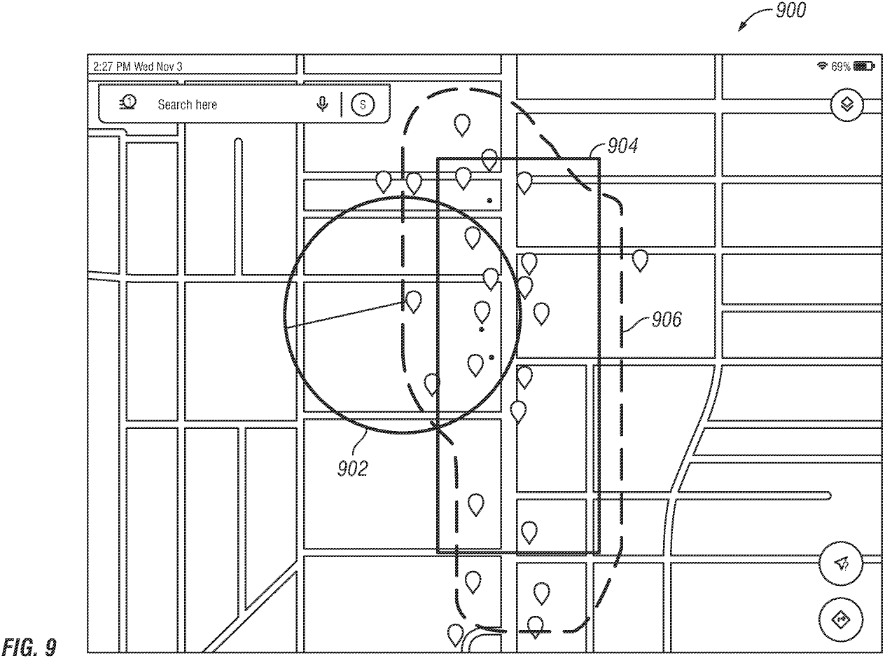

FIG. 9 illustrates a diagram of a variable zone of interaction in accordance with an illustrative embodiment. Zone of interaction 902 in digital map 900 is a circle with the user at the center. As previously mentioned, the circle can have a variable radius that can be altered by the user. For example, the user can select from one or more pre-determined radii, such as 0.25 miles, 0.5 miles, and 1.0 miles. Alternatively, the user can input a radius for the zone of interaction 902. The input can be in the form of a slider, a text field, or any number of inputs. The user can also specify a zone of interaction separate and apart from where the user is currently located. Further, the zone of interaction can be any number of geometric shapes. For example, zone of interaction 904 is a rectangle that is located apart from the user’s location at the center of zone of interaction 902. In yet another embodiment, the zone of interaction can be drawn onto a map by the user. In this illustrative example, the custom zone of interaction 906 has an irregular shape that was drawn by the user on the screen of a mobile computing device. The shape of the custom zone of interaction 906 coincides generally with known establishments in a geographic location.

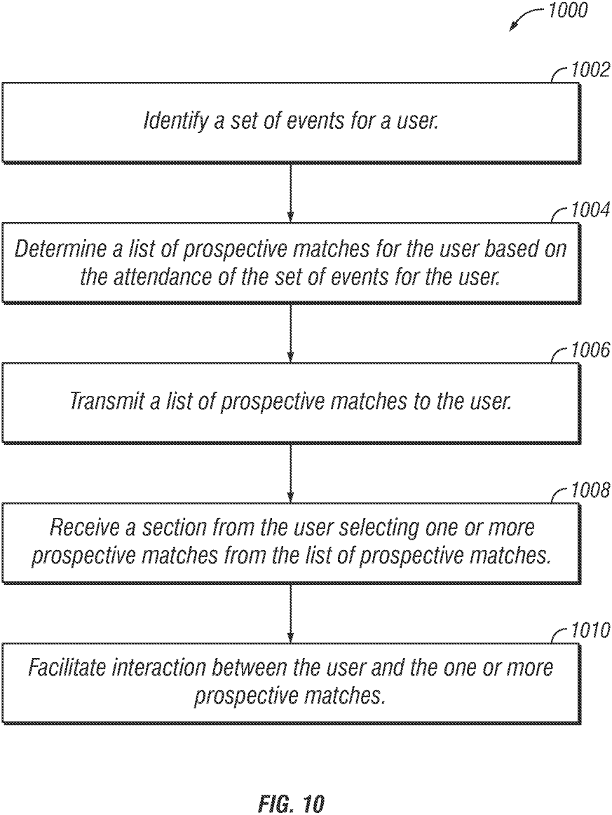

FIG. 10 is a flowchart of a process for event-based user matching according to an illustrative embodiment. Steps of flowchart 1000 can be implemented in a matching server, such as matching server 110 in FIG. 1.

Flowchart 1000 begins at step 1002 by identifying a set of events for a user. In some embodiments, the set of events for the user is identified based on a zone of interaction of the user. Further, the set of events can include a shared event between the user and each of the prospective matches in the list of prospective matches and/or a past event attended by the user and each of the prospective matches in the list of prospective matches. In some embodiments, the set of events can be identified from an invitation between the user and a set of accepting users.

In step 1004, a list of prospective matches for the user is determined. The list of prospective matches includes prospective matches attending one or more of the set of events for the user. A subset of the prospective matches can be removed from the list of prospective matches in response to detecting that the subset of prospective matches has left one of the set of events or declined to attend one of the set of events.

In step 1006, a list of the prospective matches is transmitted to the user.

In optional step 1008, a selection is received from the user that selects one or more prospective matches from the list of prospective matches, and in optional step 1010, interaction between the user and the one or more prospective matches is facilitated.

Although embodiments of the invention have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. For example, where this disclosure describes characteristics, structure, size, shape, arrangement, or composition for an element or process for making or using an element or combination of elements, the characteristics, structure, size, shape, arrangement, or composition can also be incorporated into any other element or combination of elements, or process for making or using an element or combination of elements described herein to provide additional embodiments.

Additionally, where an embodiment is described herein as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

While this invention has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. An apparatus for event-based user matching, the apparatus comprising:
a memory storing instructions; and
a processor coupled with the memory, wherein the processor is configured to execute the instructions to cause the apparatus to:
identify a set of events for a user;
determine a list of prospective matches for the user attending one or more of the set of events for the user; and
transmit the list of prospective matches for the user.

2. The apparatus of claim 1, wherein the processor is further configured to execute the instructions to:
receive a selection from the user of one or more prospective matches from the list of prospective matches; and
facilitate an interaction between the user and the one or more prospective matches.

3. The apparatus of claim 1, wherein the set of events is identified based on a zone of interaction of the user.

4. The apparatus of claim 1, wherein the set of events is a shared event between the user and each of the prospective matches in the list of prospective matches.

5. The apparatus of claim 1, wherein the set of events is a past event attended by the user and each of the prospective matches in the list of prospective matches.

6. The apparatus of claim 1, wherein the set of events is identified in an invitation from the user to a set of accepting users, wherein the list of prospective matches is based on an acceptance of the invitation by one or more users of the set of accepting users.

7. The apparatus of claim 1, wherein the process is further configured to execute the instructions to:
detect that a subset of the prospective matches has left one of the set of events or declined to attend one of the sets of events; and
remove the subset of the prospective matches from the list of prospective matches.

8. A method for event-based user matching, the method comprising:
identifying a set of events for a user;
determining a list of prospective matches for the user attending one or more of the set of events for the user; and
transmitting the list of prospective matches to the user.

9. The method of claim 8, further comprising:
receiving a selection from the user of one or more prospective matches from the list of prospective matches; and
facilitating an interaction between the user and the one or more prospective matches.

10. The method of claim 8, wherein identifying the set of events for the user further comprises: identifying the set of events based on a zone of interaction of the user.

11. The method of claim 8, wherein the set of events is a shared event between the user and each of the prospective matches in the list of prospective matches.

12. The method of claim 8, wherein the set of events is a past event attended by the user and each of the prospective matches in the list of prospective matches.

13. The method of claim 8, wherein identifying the set of events for the user further comprises identifying the set of events from an invitation between the user to a set of accepting users, and wherein determining a list of prospective matches for the user attending one or more of the set of events for the user further comprises determining the list of prospective matches based on an acceptance of the invitation by one or more users of the set of accepting users.

14. The method of claim 8, further comprising:
detecting that a subset of the prospective matches has left one of the set of events or declined to attend one of the sets of events; and
removing the subset of the prospective matches from the list of prospective matches.

15. The method of claim 8, wherein determining the list of prospective matches for the user further comprises:
receiving input from the user establishing a zone of interaction of the user; and
modifying set of events for the user based on the zone of interaction of the user.

16. The method of claim 15, wherein the zone of interaction is centered around the user.

17. The method of claim 15, wherein the zone of interaction is located apart from a location of the user.

18. The method of claim 15, wherein the zone of interaction is a shape provided by the user interacting with a graphical interface.
